(19) United States
(12) Patent Application Publication
(10) Pub. No.: US 2002/0107812 A1
(43) Pub. Date: Aug. 8, 2002

(54) Virtual marketplace

(76) Inventor: Peter Schimitzek, Geilenkirchen (DE)

Correspondence Address: Striker Striker & Stenby, 103 East Neck Road, Huntington, NY, 11743, US

(21) Appl. No.: 10/048,875

(22) PCT Filed: Apr. 14, 2001
(86) PCT No.: PCT/DE01/01482

(30) Foreign Application Priority Data
Jun. 3, 2000 (DE) 100 27 712.8

(51) Int. Cl. H04K 1/00; H04L 9/00; G06F 17/60

(52) U.S. Cl. 705/64

(57) ABSTRACT

The invention describes a universal virtual marketplace (1) which maximises use in the national economy, reduces the detrimental aspects of e-commerce and, both for sellers (4) and purchasers (5), secures all necessary safeguards and rights in business transactions, wherein all active parties are connected to each other via a network (3).

The business competence of sellers (4) to operate in the virtual marketplace (1) is proved by acceptance into the database of an accreditation module (9) and the business competence of to purchasers (5) is proved by acceptance into the database of a certification module (10), wherein by means of an administration element (2) in connection with a checking module (8) for checking and monitoring the reputableness of the sellers (4) and purchasers (5) a decision is made over accreditation or certification thereof in terms of business, legal and also moral aspects.

The invention relates to the formation and coupling of mutual connections between customers and sellers in a virtual marketplace.

Business transactions on both a small and also a large scale are increasingly being carried out using open networks, in particular the Internet. An inestimably large number of virtual marketplaces with mixed and/or specific products for sale, and self-contained markets in the Business to Business form have developed. E-commerce as an integrated system for sales, consultation, information and service has now become relatively cumbersome to use or only practicable in specific sectors both for the private and for the professional user because of the large number of marketplaces and information sources to be visited which are offered to the user and have to be sifted through according to his requirements.

The conclusion of virtual contracts and payments is becoming increasingly secure thanks to specific processes, but cannot be totally secured against deliberate misuse, so that considerable damage is done to the national economy and confidence is undermined.

Particular processes for buying via networks are described in a large number of published protected rights. Thus, for example in the document WO 96/13013 a sales system using networks is disclosed in which a purchaser uses a PC to place an order for a product with a trader on the basis of an enquiry or a proposal, initiates payment to the trader in connection with a specific product code via a payment computer, the payment computer transfers the amount to the trader and the trader supplies the goods to the purchaser, wherein during the steps of the transaction process the data are authenticated and verified by means of digital signatures. An electronic system for purchase mediation via an interactive network is described in document U.S. Pat. No. 5,878,141, which has, amongst other components, a purchaser and a trader database which are coupled together via a processor in order—in the event of an enquiry from the purchaser—to match up the types of payment possible for the purchaser and acceptable to the trader. After agreement as to the payment type a transaction including mutual authentication and verification is concluded and the purchaser receives his goods. In the document U.S. Pat. No.5,794,221 a process for settlement of account for services acquired by a customer via the Internet including conventional security standards is described, in which the service is paid for through a customer account with the customer's Internet provider, wherein the Internet provider receives commission from the seller.

It is a common aspect of known e-commerce payment systems that, depending upon the individual transaction conditions, the customer may have considerable problems in seeking redress if there is a defect and the seller is not protected against fraudulent use of payment systems in spite of conventional security standards.

It is the object of the invention to create a universal virtual marketplace which maximises use in the national economy, reduces the detrimental aspects of e-commerce and, both for sellers and purchasers, secures all necessary safeguards and rights in business transactions.

The object is achieved by the features set out in claim 1. Preferred developments are given in the subordinate claims.

The formation of the virtual marketplace in accordance with the invention, to which - in a known manner—sellers are connected via search and meta-search engines, makes it possible for each visitor [lacuna] the information about everything that is offered. A differentiation is made between surfers and authorised purchasers for companies, groups or private individuals for initiation and processing of e-commerce business processes.

A virtual marketplace of this type has market administration in the form of a central administration in which all sellers and purchasers operating in the marketplace are accredited or registered.

Accreditation or acceptance into the register is decided by the market administration, wherein the reputableness of the respective seller or purchaser is checked under consideration of business, legal and also moral factors, and they are categorised into hierarchical levels.

In dependence upon the categorisation into a specific level, authorisation can be given for the type and scope of business which can be carried out.

The highest level of purchasers preferably includes the purchasers for companies and groups which are certified by the market administration.

The certification of purchasers contains data necessary for legal transaction business to be carried out, such as, for example the number of the entry in the commercial register, taxation identification number, business number, cost centre, function, name and statements about financial soundness and legally secured, reinsured ability to complete the transaction.

Acceptance of a purchaser into the register proves this purchaser's business competence for the virtual marketplace, the same applies to the accreditation of sellers.

The data records of accredited sellers contain, in addition to the data required for legal transaction business and secure transactions, the business conditions and, for example special authorisations thereof.

Accredited sellers can gain access to the data appertaining to the purchasers. Certified purchasers can have access to the relevant entries for the accredited sellers.

For the purpose of securing a transaction process, in particular delivery resulting from a proposal and payment therefor, in a way which protects the seller and the purchaser trust accounts and a conciliation agency are implemented in the central administration in the form of the market administration.

The network address is used as the smallest component forming a basis for entries in the register, all connections and operation of the virtual marketplace.

In carrying out e-commerce transactions conventional processes are used for authorisation, authentication, verification, encryption and security standards for transactions.

The maximum possible security is achieved for each participant both legally and also in terms of business by means of the interaction between the individual elements of the universal virtual marketplace and the cooperation between these elements, whereby economic and moral damages are considerably avoided.

Problems in individual transactions can be sorted out between the parties in a very short time by the conciliation agency assigned to the independent administration.

All forms of proposals can be placed regardless of the sector, ranging from material objects and intangibles to consultations and even to services.

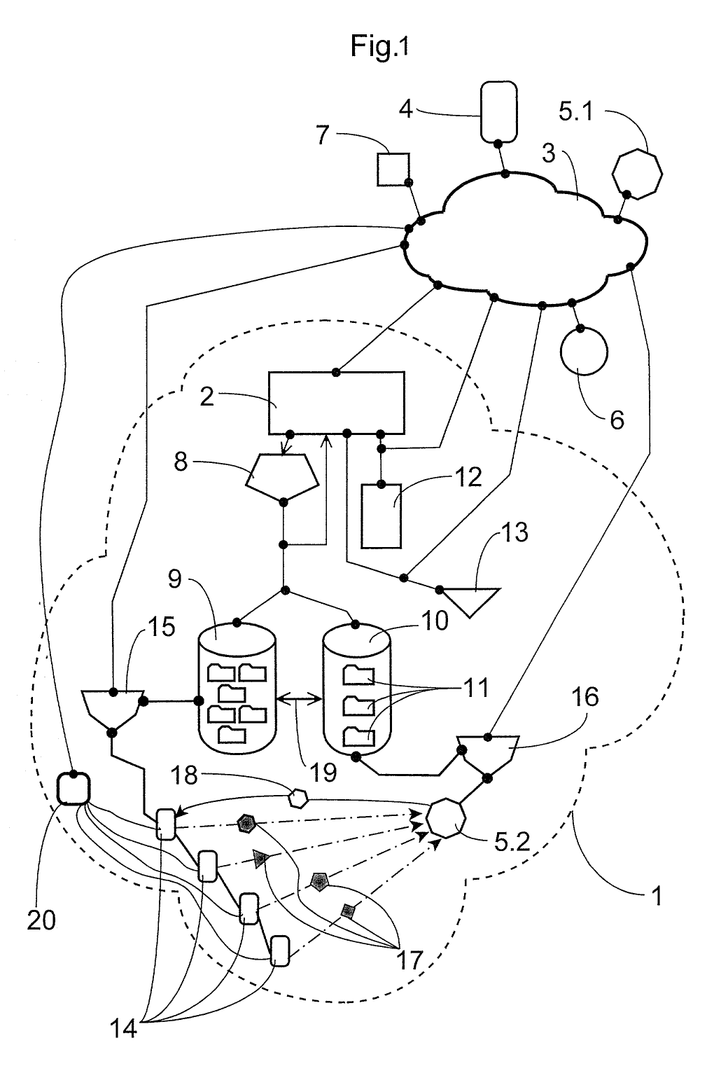

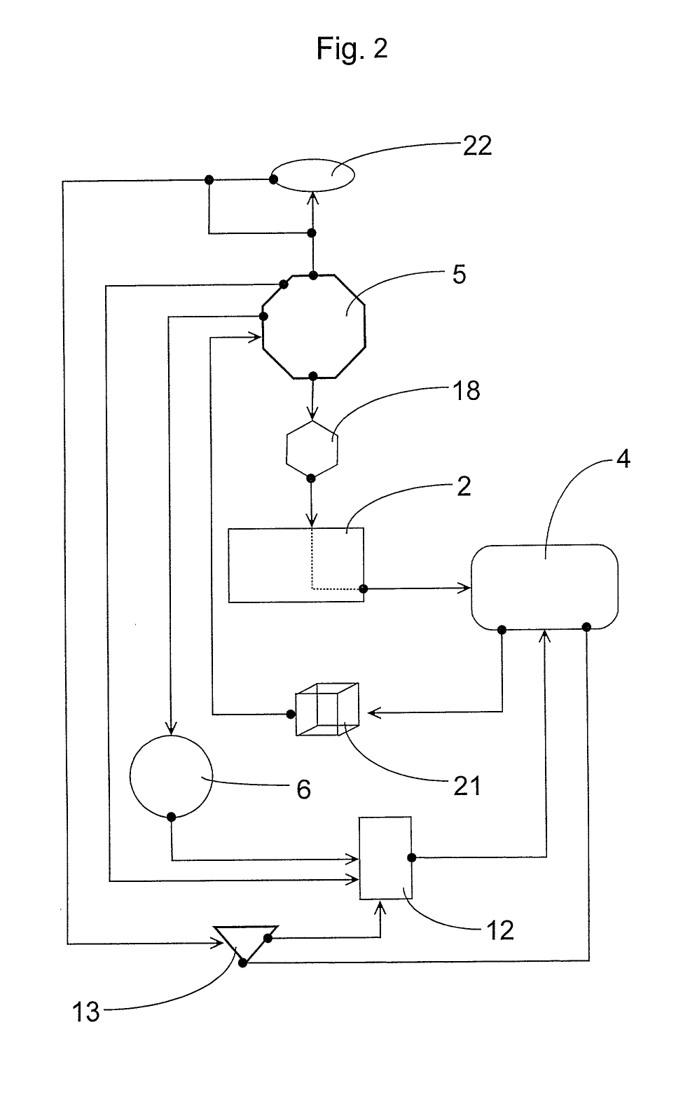

The connection of the essential elements of a virtual marketplace is described in more detail as an exemplified embodiment with the aid of FIG. 1 as an illustration of the principle of cooperation between the elements of a virtual marketplace and FIG. 2 as an illustration of a transaction process.

A virtual marketplace 1 has a central administration element 2 which [lacuna] with an open network 3, for example the Internet, via which sellers 4, purchasers 5 (5.1; 5.2), financial services providers 6 and credit enquiry agencies 7, such as Schufa, and specific company registers are connected to each other. The sellers 4 and purchasers 5 first connect to the administration element 2 via the network 3 in order to apply for acceptance in the virtual marketplace 1, this administration element checks the reputableness of the sellers and purchasers by interacting with a checking module 8 using predetermined criteria and feedback via the administration element 2 and the network 3 concerning data stored by financial services providers 6 and also credit enquiry agencies 7 and relating to sellers 4 and purchasers 5. If this check produces a positive result the checking module 8 permits entry of the sellers 4 into the database of an accreditation module 9 connected thereto. In a similar manner, purchasers 5 are entered in the database of a certification module 10 also connected to the checking module 8. The clearly allocated network addresses in URL form serve in each case as a basis for the registrations. The purchasers 5 are allocated different levels of certification 11 depending upon their status as a company or group representative or as a private person. Furthermore, a trust module 12 and a conciliation element 13 are also allocated to the administration element 2 and are connected both to this administration element and also—via the network 3—to all participating and active parties.

Placement of services in the form of seller suites 14 in the virtual market 1 is carried out by means of a seller port 15 acting as a filter and connection element, which seller port is connected to the accreditation module 9. The seller 4 makes a connection via the network 3 to the seller port 15, wherein this comes to interact with the accreditation module 9 and, if the seller 4 is accredited, releases, access to the placement of the services in the seller suites 14.

The purchaser 5.2, who, after a positive check of his certification, obtains access—so as to be able to do business—to the virtual marketplace 1 via a purchaser port 16 operating as a filter with the network 3 and the certification module 10 with the respective level of certification 11, calls up proposals 17 from the services offered by the different seller suites 14, selects therefrom the service he wants and issues a request 18, which the network 3 transmits to the seller 4 from the seller suite 14 via the seller port 15 for processing and delivery of the service. In addition, all services offered in the virtual marketplace 1 and all transactions carried out can be detected and monitored by the administration element 2 via the connection to the accreditation module 9 and trader port 15. By means of feedback and mutual data exchange with the trust module 12 included in the transaction process - to be explained in more detail with the aid of FIG. 2—between the seller 4 and the purchaser 5 (5.1; 5.2), and also by means of the conciliation element 13 a continuous check on the reputableness of the accredited sellers 4 and of the purchasers 5 is carried out by additional involvement of the financial services providers 6 and of the credit enquiry agencies 7, wherein data in the modules 9; 10 are supplemented and, if a severe objection is met, access to the virtual marketplace 1 is blocked. It is possible for the accredited sellers 4 and certified purchasers 5, after the granting of access by means of the ports 15; 16 to find out about their own data entered in the modules 9; 10 and also—via a link 19—about the data in the respective other module 10 and 9.

By means of a guest port 20 connected to the network 3 it is possible for third parties who have network access to find out about the services offered in the seller suite 14, wherein, however, it is not possible for this third party to use the virtual marketplace 1.

The transaction process between the seller 4 and the purchaser 5 after selection of a proposal 17 is shown more clearly in FIG. 2. The purchaser 5 issues to the seller 4 a request 18 for delivery of goods 21, which request is detected and monitored by the administration element 2. After a check is again made, in the manner described above, as to the reputableness of both parties, the request is tacitly permitted if there are no negative aspects, however, in the presence of negative information about one of the parties, then appropriate statements are generated which are transmitted to both parties and can lead to the transaction process being terminated. If the request 18 is received by the seller 4, the seller initiates delivery of the goods 21 to the purchaser 4, who, after receipt thereof, authorises payment via a financial services provider 6. The transfer of payment from the financial services provider 6 to the seller 4 is made via a trust module 12 which releases the payment when it has received notice from the purchaser 4 that the goods 21 have been delivered in an acceptable condition. If there is a defect 22, a corresponding data record is transmitted to the conciliation element 13, which connects to the seller 4. Once the defect 22 has been corrected or an agreement is reached between the purchaser 5 and the seller 4, corresponding information is transmitted to the conciliation module 13 by the purchaser 5, in such a manner that the conciliation module 13 forwards this information to the trust module 12 and this trust module makes the payment or modified payment to the seller 4.

The data exchange between the parties operating in the virtual marketplace 1 takes place in the known manner in dependence upon the security level required in each case including known security standards and encryption techniques.

Reference numbers used

1 virtual marketplace

2 administration element

3 network

4 seller

5 purchaser (5.1; 5.2)

6 financial services providers

7 credit enquiry agencies

8 checking module

9 accreditation module

10 certification module

11 certification levels

12 trust module

13 conciliation element

14 seller suite

15 seller port

16 purchaser port

17 proposal

18 request

19 link

20 guest port

21 goods

22 defect

1. Universal virtual marketplace in which all active parties are connected to each other via a network, characterised in that
the business competence of sellers (4) to operate in the virtual marketplace (1) is proved by acceptance into the database of an accreditation module (9) and the business competence of purchasers (5) is proved by acceptance into the database of a certification module (10), and
by means of an administration element (2) in connection with a checking module (8) for checking and monitoring the reputableness of the sellers (4) and purchasers (5) a decision is made over accreditation or certification thereof in terms of business, legal and also moral aspects:

2. Universal virtual marketplace according to claim 1, characterised in that entitlement to the scope of a possible business transaction of the purchasers (5) is dependent upon inclusion of the purchaser in one of the certification levels (11) of the certification module (10).

3. Universal virtual marketplace according to claims 1 and 2, characterised in that the placement of services by the seller (4) after access via a seller port (15), which acts as a filter and connection element, takes place using a seller suite (14).

4. Universal virtual marketplace according to claims 1 to 3, characterised in that the purchasers (4) have access via a purchaser port (16) operatively connected to the certification module (10) and acting as a filter.

5. Universal virtual marketplace according to claims 1 to 4, characterised in that sellers (4) can look at their own data stored in the accreditation module (9) and, by means of a link (19), can access data of the ordering purchaser (5) in the certification module (10).

6. Universal virtual marketplace according to claims 1 to 5, characterised in that purchasers (5) can look at their own data stored in the certification module (10) and, by means of a link (19), can access data of the seller (4).

7. Universal virtual marketplace according to claims 1 to 6, characterised in that the administration element (2) monitors transaction processes and again checks the reputableness of the sellers (4) and purchasers (5) involved by interaction with the entries in the databases in the certification module (10) and also the accreditation module (9) when a request (18) is issued and
that negative entries in the databases can cause statements to be transmitted to both parties and the transaction process can be broken off by the administration element (2).

8. Universal virtual marketplace according to claims 1 to 7, characterised in that a trust module (12) and a conciliation element (13) to secure and monitor the secure progress of a transaction process between the seller (4) and the purchaser (5) are allocated to the administration element (2).

9. Universal virtual marketplace according to claims 1 to 8, characterised in that payment for the delivery of goods (21) is made after authorisation by the purchaser (5) from a financial services provider (6) with intermediate involvement of a trust module (12), wherein payment is released to the seller (4) after confirmation by the purchaser (5) that the delivery is in an acceptable condition.

10. Universal virtual marketplace according to claims 1 to 9, characterised in that in the case of a defect (22) in the goods (21) a corresponding data record is transmitted to a conciliation element (13) which blocks the further transfer of the payment through the trust module (12) to the seller (4) and
after agreement between the purchaser (5) and the seller (4) the conciliation element (13) transmits to the trust module (12) the command for further transfer of a payment, which may even be modified, to the seller (4).

11. Universal virtual marketplace according to claims 1 to 10, characterised in that the network address of the sellers (4) and purchasers (5) is used as a basis for the entries into modules (9; 10), the connections and all operations.

12. Universal virtual marketplace according to claims 1 to 11, characterised in that conventional security standards and encryption processes are used in a known manner for data transfer between the active parties.
